(19) United States
(12) Patent Application Publication
(10) Pub. No.: US 2010/0245595 A1
(43) Pub. Date: Sep. 30, 2010

(54) RECORDER TEST SYSTEM

(75) Inventor: Glenn C. Waehner, Fresno, CA (US)

Correspondence Address: Herbert W. Spencer III, 23629 Mill Valley Rd., Valencia, CA, 91355, US

(73) Assignee: ACUITY SYSTEMS INC., NEW WINDSOR, NY (US)

(21) Appl. No.: 12/750,668

(22) Filed: Mar. 30, 2010

Related U.S. Application Data
(60) Provisional application No. 61/165,088, filed on Mar. 31, 2009.

(51) Int. Cl. H04N 17/00

(52) U.S. Cl. 348/192; 348/E17.001

(57) ABSTRACT

A system is described that provides a full end to end test of a recorder system to assure that a failure of any one or more channels is quickly detected so that maintenance can be performed.

The system causes the recorder to sequence all or some of its outputs so that they appear sequentially on one (or more to increase speed) video signal line. The testing system uses one (or possibly multiple) testing circuits to check the signal from each recorder channel as it appears in the sequence. If one or more channels are inoperative, they are identified and a maintenance needed alarm is generated.

The sequence includes a pause or similar discontinuity so that the tester can synchronize to the sequence so that the specific identifier of a channel can be identified with the detected operating status. This identification is also possible from communication between the tester and the recorder.

The system can automatically transfer a failed channel to a spare channel to allow continued recording until maintenance corrects the failure.

A method is described to deal with stationary camera scenes so that a static non moving image is not confused with a failed channel. The system can be used with existing installed systems, included with new systems, or fully integrated into new recorder designs.

This application is related to and claims the benefit of U.S. Provisional Patent Application Ser. No. 61165088 filed Mar. 31, 2009, entitled Recorder Test System, the entirety of which is incorporated herein by reference.

### BACKGROUND OF THE INVENTION

Digital video recorders are very common in the CCTV industry. Many of these use hard drives as the primary video data storage device, often in cooperation with some form of recorder controller or personal computer. They are often designed to record multiple channels video of data. These recorders provide rapid search and view capability, and often many weeks of recording before the hard drive or similar memory is full, and at this time they either stop or begin to overwrite the oldest data. Thus, the recorder can go many weeks without operator attention.

If there is some form of failure, the recorder may stop recording one or more channels of data without the operator being aware of the failure. During this time, critical events may not be recorded, and important information or evidence is lost. Even if some channels were accessed and found to be recording correctly in the normal course of use, others may be inoperative and not noticed until an event occurs and the review of that time shows that no video or audio data is available. This causes great concern for the users of these systems, with some applications, such as casinos, being obligated to a very high percentage of cameras recording or they must shut down and perform maintenance.

In some cases, an entire recorder fails and some units can issue a failure alarm. However, these limited attempts to sense and report a failure usually do not cover or protect the full record process, with the net result that some or all channels will be missing for extended time periods but not reported. Tape based systems also suffer these types of failures, but at least you can sometimes see if the tape is advancing if you are physically at the machine. In summary, the failure of recorders is a significant problem.

### SUMMARY OF THE INVENTION

In summary a digital recorder test system is provided that selects and plays back individual recording channels and sequentially tests each one to confirm that the image is actually being recorded and not blank or frozen or of unacceptable quality. For cases where the camera image is often not changing (as in a hallway at night) an unobtrusive or totally hidden signal is that is continuously changing, or detecting a time clock if present in the image or the camera data, so that active recording can be detected. Alternately testing the camera and recording channel by storing an image and then comparing it to a later image to see if the image has changed. Alternately, forcing a change in the recorded image by injecting or including a continuously changing detectable signal for testing or forcing a change in the recorded image by turning off the camera by removing the power or commanding a different setting, or by moving the camera to change the scene. The system can be used to detect poor image quality by testing the camera inputs sequentially before recording so that maintenance (lens cleaning, focus, camera repair, wiring repair) can be scheduled. This input check can be performed on a regular basis in addition to testing for recording failure.

A combination of these can be used to determine when to notify the user by local alarm or remote wireless means of any detected failure so that maintenance can be performed.

To speed up testing using more than one selecting and testing system to speed up the sequential process as required. This can be done by assigning groups of cameras to specific testing means, or by employing multiple testing systems on all cameras but starting at different points in the channel test sequence. For example, with three test systems on could test inputs, one could start at the first recording channel and the third starting in the middle of the sequence. This approach cuts the test time in half, and also provides redundancy in the test process should part of the test system fail. Alternately testing some priority cameras more often or a specific camera continuously rather than many sequentially. The system can have the ability to switch a failed camera channel to a different functional recording channel and if still not working identifying the camera itself as the possible fault. These features can be designed to be built in as feature into new designs or to be added as a separate testing system to existing video systems.

### BRIEF DESCRIPTION OF THE DRAWINGS

So that the manner in which the above recited features of the present invention can be understood in detail a more particular description of the invention briefly summarized above maybe referenced to the embodiments, some of which are illustrated in the appended drawings. It is to be noted, however that the appended drawings illustrate only typical embodiments of this invention and are therefore not to be considered limiting its scope, for the invention may admit to other equally effective embodiments.

FIG. 1 illustrates the basic recorder testing system

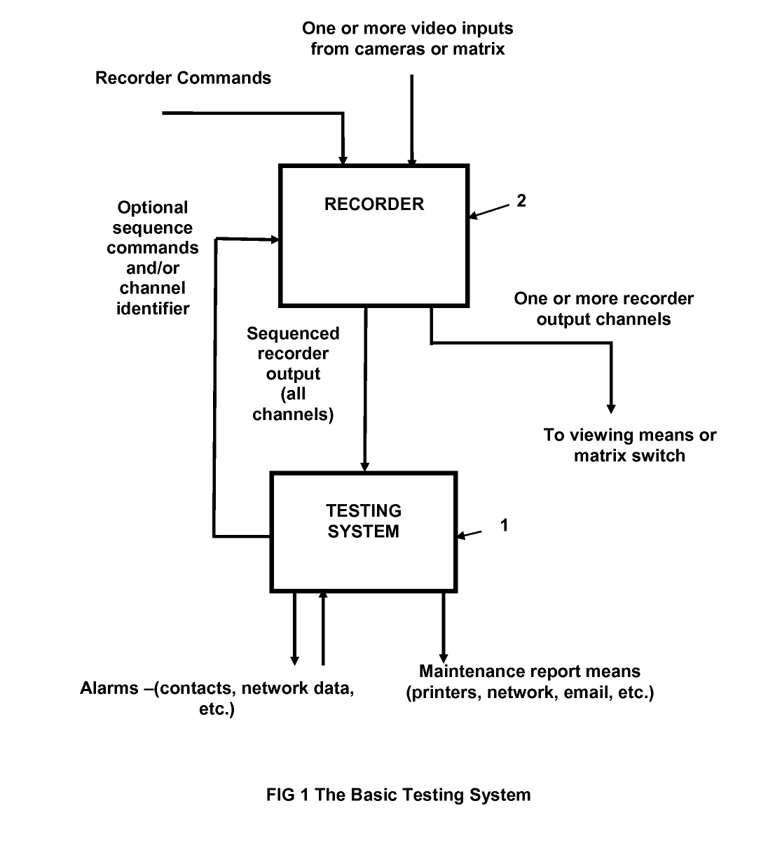

FIG. 2 illustrates the recorder testing system with a switch means.

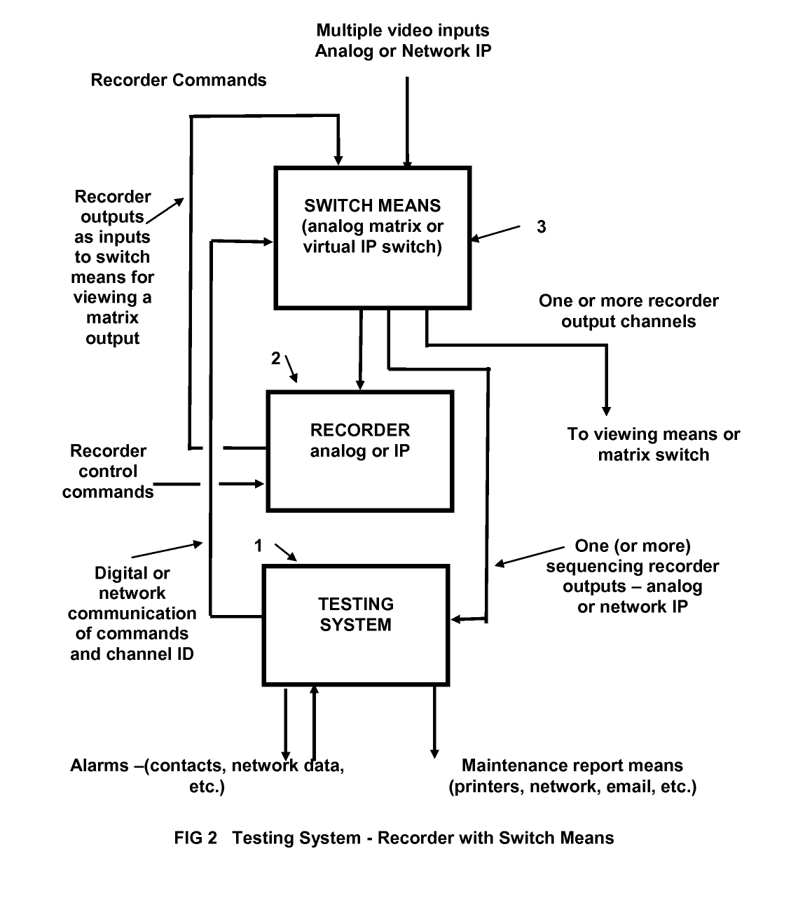

FIG. 3 illustrates the recorder test system with a signal injector.

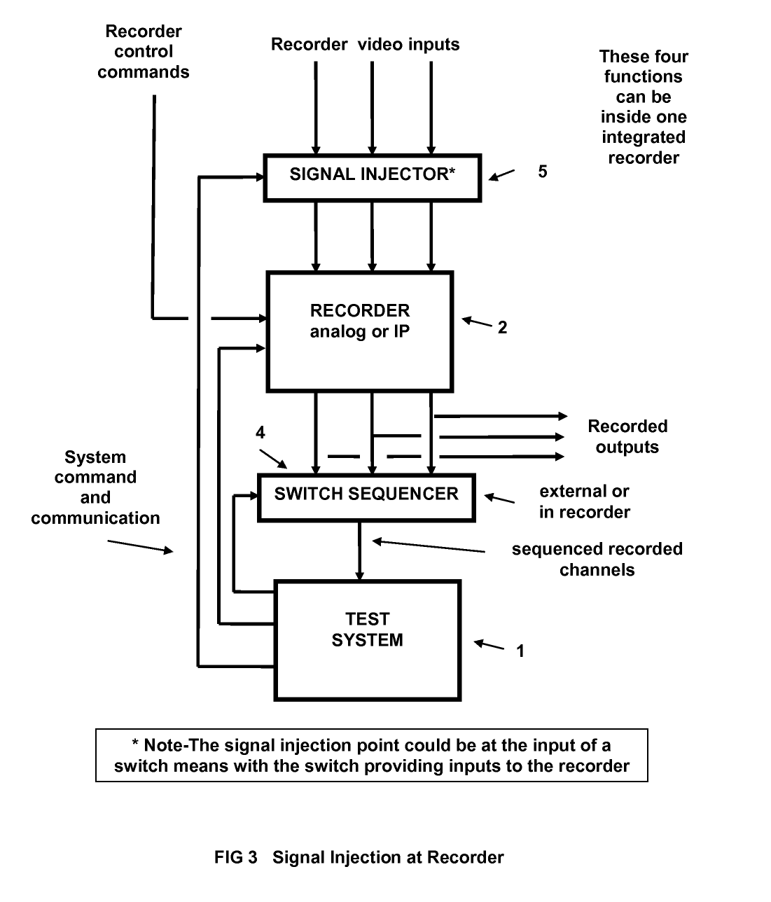

### DETAILED DESCRIPTION OF THE INVENTION

To solve this issue, a video presence detection system that tests or monitors cameras, can be used to look at each output of the recorder outputs sequentially or individually to determine if real video is present. This selecting or sequencing can be accomplished by causing one output channel of the recorder 2 or associated matrix switch to switch or sequence quickly through each channel of the recorder 2. If any channel is inoperative, the system will issue a maintenance alarm. If each camera was observed for five seconds by the system, a 100 camera recorder can be fully tested in less than ten minutes, and this can be done continuously. For larger systems, the recorder 2 outputs are connected to the main matrix system (the main camera switching and control device in the video system 3), so instead of using recorder 2 outputs directly, one can let the matrix do the selecting or sequencing. In this way, a portion of the matrix is also tested. For the case where a camera is looking at a scene where there is no activity, it can be uncertain whether the image is being recorded properly or is frozen or stopped and not actually being recorded. In this event, one can inject a changing or sequencing signal into the video as if part of each record channel input using a signal injector 5. This signal can be located in the corner of the video image or anywhere that makes it less visible or obtrusive. This could be done at the input channels of the recorder or in the switch if one is involved. Typical switches 3 already mix time and date information with the video, automatically solving this problem. In this way, even a stationary image could have detectable movement that can be sensed and if absent used as a failure indicator. Many matrix and recording systems are network based, or have RS422 or USB control and communication capabilities. This provides a simple access point for the testing system to command an existing recorder 2 or matrix switch 3 to sequence through some or all of its channels. If a network system, this can be accomplished by commanding the checking device to select the specific recorder 2 channel streams sequentially by IP address. If a matrix or similar switch 3 exists, one can command individual recorder 2 channels to the test device output through a system command input. Alternately, one can usually set the switch to sequence between all recorder 2 channels and pause or similar pattern change to facilitate the tester's synchronization to the sequence. If from a network based system, the network address identifies the recorder 2 output. In either case, the checking device (testing system 1) knows which recorder 2 channel is being tested because it commanded it and can create the appropriate alarm or maintenance report. If the sequence is not commanded by the test system, the sequence can be entered into the test system which can follow the sequence if a starting pause or similar synchronizing means is provided to identify the sequence start to the test system.

Both the testing device 1 and the test signal injector 2 can be built into new recorder designs, rather than connected externally to an input and output, to simplify and automate the testing process. If designed into a new recorder, the entire process can be transparent to the user. These channel knowledge issues can easily be determined within a built in version, as the needed data is already within the box. Similarly, inserting signals to accommodate no activity images can also be easily designed into the unit. It is also contemplated that the proposed test system would integrate with the video control system and provide alarms to the central system for distribution, receive mode controls and commands to cancel alarm signals, and switch failed channels to working spare channels (this could be done automatically) to delay the need for immediate maintenance. The test system 1 can employ multiple channels or multiple independent units to speed up the test process or provide test redundancy. If two units were used on an N channel system, they could be set to start at N=0 and N/2. This would still cut test time in half and also provide redundancy automatically. Similarly, for more than two test devices or channels this process can easily be extended.

In the preferred embodiment the degree or type of change needed to declare an alarm or maintenance required can be selectable. Also the waiting time between comparisons can be selectable on a channel by channel basis, or a higher priority channel included in the test sequence more than once to give a fast response or less often for a longer term check for images that only change slowly, such as morning versus afternoon, or day versus night. This is an alternative to adding or injecting a test signal to create detectable change.

Various test signals and processes can be used individually and collectively with the above hardware concept to sense that a recorder is running properly. One can look for synchronization signals, compare one frame to the next to see that it has changed, check for changes in intensity within a frame, inject a test signal at signal injector 5 and test it for quality and presence, and numerous other possibilities known to those skilled in the art. Regardless of the method, offering a recording system that has every channel continuously tested end to end, assures channel operation and is a significant market advantage.

Some Key Ideas are:

Checking the recorder 2 operation fully end to end and not just selected modules or recently selected channels.

Adding changing information to the picture input that can be sensed at the recorder output to confirm operation for fixed or other harder to test scenes.

Causing the recorded outputs to be sequenced so each can be checked. This sequence can include higher priority channels more often, or low priority channels less often. If the analog or IP channel is commanded by the test system, it already knows what channel it is looking at. If simply looking at a sequenced output, one needs to get data from the sequencing device to know which channel is under test, or provide a synchronizing pause if the sequence is generated in the matrix or recorder switch and not commanded by the test system.

The testing system 1 providing various alarm signals to the video system by wired connection, network communication, E-mail, or phone texting, or similar means.

The testing system 1 automatically selects a spare channel 5 if a failure is detected.

The testing system 1 being deployed as multiple units or channels, to speed up the test process or provide testing redundancy

Allowing the use of alternate test algorithms to determine that a failure has occurred, or using more than one algorithm simultaneously to obtain a more complete test. Alternate algorithms could be used in separate channels.

The description above is not intended to convey every detail and concept in this disclosure. It is clear to those skilled in the art that the concepts disclosed represent preferred embodiments and can be adapted to other hardware and configurations to accomplish the desired end result described.

What is claimed:

1. Automatically, selecting and playing back one or more individual recording channels of a multi- channel recording system and sequentially testing them to confirm that the image is actually being recorded and not blank or frozen and notifying the user by local alarm, remote wireless, or similar means of any detected failure so that maintenance can be performed.

2. In claim 1 for cases where the camera image is not changing, injecting an unobtrusive or totally hidden signal that is continuously changing, or detecting a time clock or similar item if present in the image or the camera data, so that active recording can be detected and confirmed and not interpreted as a frozen or failed recording channel. Testing the camera and recording channel by storing an image or the data and then comparing it to a later image or data to see if any portion of the image or data has changed.

3. In claim 1 including specific cameras more or less often in the test sequence to increase or decrease the frequency of testing.

4. In claim 1 forcing a change in the recorded image to confirm recording, by commanding a different camera setting, momentarily de-selecting it, moving the camera to change the scene, or a similar means

5. In claim 1 detecting poor image quality rather than or in addition to total recording failure so that maintenance (lens cleaning, focus, camera repair, wiring repair) can be scheduled.

6. In claim 1 Using more than one selecting and testing system to speed up the sequential testing process as required.

7. In claim 1 using more than one test channel to provide test redundancy

8. In claim 1 switching the failed camera channel to a different functional recording channel and if still not working identifying the camera itself as the possible fault.

9. In claim 1 building this feature into new designs or adding it as a separate testing system to existing video systems.

10. In claim 1 making the degree or type of change needed to declare an alarm or maintenance required selectable.

11. In claim 1 making the waiting time between comparisons selectable on a channel by channel basis to give a fast response for rapidly changing images, or longer term check for images that only change slowly.

12. In claim 11 with a selectable mode where a longer term or repeated comparison is automatically selected as a means of confirming a failure if the short term comparison detects a failure.

13. in claim 1 where the system also checks camera inputs for image quality or integrity to identify needed maintenance
